(19) United States
(12) Patent Application Publication
(10) Pub. No.: US 2012/0288633 A1
(43) Pub. Date: Nov. 15, 2012

(54) Novel Composite Material and its Production Method

(76) Inventor: Wenyi Zhang, Dongguan City (CN)

(21) Appl. No.: 13/207,409

(22) Filed: Aug. 10, 2011

(30) Foreign Application Priority Data
May 12, 2011 (CN) PCT/CN2011/073962

(51) Int. Cl. B05D 3/02

(52) U.S. Cl. 427/385.5

(57) ABSTRACT

A novel composite material and its production method, which contains a wearing layer made of polymer PP, a colored layer made of ink and a printing layer made of polymer PP. The production method of this novel composite material includes the following steps: (1) a colored layer is formed by printing adhesive ink onto the printing layer of polymer PP; (2) the colored layer and printing layer are thermally polymerized with a wearing layer made of polymer PP. The material of the present invention can be applied to produce many products due to its recoverability and degradability under natural conditions, as well as tight bonding and excellent environmental friendliness without gluing chemical composition among the layers; besides, it presents outstanding temperature resistance and fireproofing performance without deformation.

### BACKGROUND OF INVENTION

1. Field of the Invention

The present invention relates generally to a composite material, and more particularly to an innovative one,

2. Description of Related Art

At present, wood-imitation floor tiles, fan blades, wood-imitation furniture/windows and decorative materials are generally made of PVC materials, which, however, are not easily degraded and not beneficial to environmental protection due to poorer recoverability.

### SUMMARY OF THE INVENTION

The purpose of the present invention is to provide a novel composite material and its production method; this composite material can be used in a broad range of applications due to its strong temperature resistance and environmental performance.

The production method of the novel composite material includes the following steps:
(1) A colored layer is formed by printing adhesive ink onto the printing layer of polymer PP;
(2) The colored layer and printing layer are thermally polymerized with a wearing layer made of polymer PP.

As a preferred option of said technical scheme, after completion of step (2), the bottom of the printing layer is thermally polymerized with the stable layer made of polymer PP (3).

As a preferred option of said technical scheme, after completion of step (3), the bottom of the stable layer is thermally polymerized with the deflation/silencing layer made of polymer PP (4).

As a preferred option of said technical scheme, after completion of step (4), the bottom of the deflation/silencing layer is thermally polymerized with the heat-insulation layer made of polymer PP (5).

As a preferred option of said technical scheme, said thermal polymerization is performed under the conditions of 100˜300° C. and 100˜3000 kg.

The novel composite material of the present invention contains a wearing layer made of polymer PP, a colored layer made of ink and a printing layer made of polymer PP from top to bottom.

As a preferred option of said technical scheme, the bottom of said printing layer is thermally polymerized with the stable layer made of polymer PP.

As a preferred option of said technical scheme, the bottom of said stable layer is thermally polymerized with the deflation/silencing layer made of polymer PP.

As a preferred option of said technical scheme, the bottom of said deflation/silencing layer is thermally polymerized with the heat-insulation layer made of polymer PP.

The benefits of the present invention lie in that: this material can be applied to produce many products due to its recoverability and degradability under natural conditions, as well as tight bonding and excellent environmental friendliness without gluing chemical composition among the layers; besides, it presents outstanding temperature resistance and fireproofing performance without deformation.

### BRIEF DESCRIPTION OF THE DRAWINGS

FIG. 1: a structural view of the preferred embodiment of the present invention;

FIG. 2: an A-A sectional view of FIG. 1;

FIG. 3: another A-A sectional view of FIG. 1.

### DETAILED DESCRIPTION OF THE INVENTION

The following is a detailed description of the present invention. However, it should be appreciated that the scope of the following claims is not restricted.

The production method of the novel composite material includes the following steps:
(1) A colored layer (with various patterns such as: woody and marbleized) and a printing layer are formed by printing with BOPP and water-based. ink (by adding 50%˜70% adhesive to protect the pigment of ink);
(2) The colored layer and printing layer are thermally polymerized with the wearing layer of polymer PP under 100° C. and 1000 kg;
   The following steps are performed subsequently:
(3) The bottom of the printing layer is thermally polymerized with the stable layer (reinforced layer) of polymer PP under 170° C. and 1000 kg, so as to enhance the strength of the product;
(4) The bottom of the stable layer is thermally polymerized with the deflation/silencing layer of foamed polymer PP under 170° C. and 1000 kg, so as to increase the thickness of the product;
(5) The bottom of the deflation/silencing layer is thermally polymerized with heat-insulation layer of polymer PP under 170° C. and 1000 kg, since the rugged bottom of the heat-insulation layer could ensure good heat-insulation performance of the product.

The novel composite material of the present invention could be used to produce wood-imitation floor tiles, fan blades, wood-imitation furniture/windows, packing boxes and decorative materials, etc.

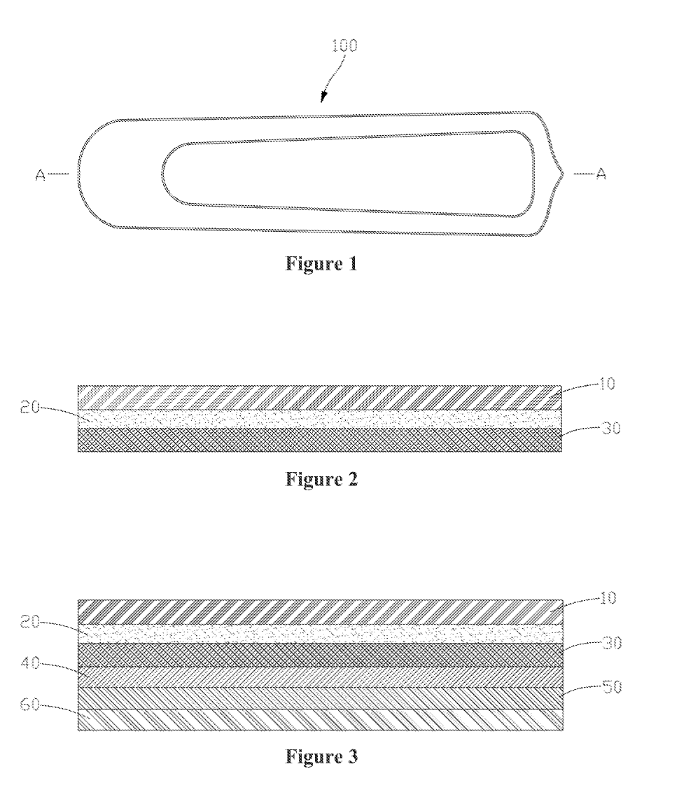

FIGS. 1 and 2 illustrate structural views of a preferred embodiment of fan blade 100 made of the novel composite material of the present invention, which contains a wearing layer 10 made of polymer PP, a colored layer 20 made of water-based ink and a printing layer 30 made of BOPP from top to bottom.

FIG. 3 illustrates a structural view of another preferred embodiment of the composite material of the present invention, which contains a wearing layer 10 made of polymer PP, a colored layer 20 made of water-based ink, a printing layer 30 made of BOPP, a stable layer 40 made of polymer PP, a deflation/silencing layer 50 made of foamed polymer PP and a heat-insulation layer 60 made of foamed polymer PP.

It is worthy to note that: the stable layer 40, deflation/silencing layer 50 and heat-insulation layer 60 can be selected where necessary.

1. A production method of a novel composite material, which includes the following steps:
(1) a colored layer is formed by printing adhesive ink onto the printing layer made of polymer PP;
(2) the colored layer and printing layer are thermally polymerized with a wearing layer made of polymer PP.

2. The production method of a novel composite material as claimed in claim 1, wherein, after completion of step (2), the bottom of the printing layer is thermally polymerized with the stable layer made of polymer PP (3).

3. The production method of a novel composite material as claimed in claim 2, wherein, after completion of step (3), the bottom of the stable layer is thermally polymerized with the deflation/silencing layer made of polymer PP (4).

4. The production method of a novel composite material as claimed in claim 3, wherein, after completion of step (4), the bottom of the deflation/silencing layer is thermally polymerized. with the heat-insulation layer made of polymer PP (5).

5. The production method of a novel composite material as claimed in claims 1 to 4, wherein said thermal polymerization is performed under the conditions of 100˜300° C. and 100˜3000 kg.

6. The production method of a novel composite material as claimed in claim 1, wherein the novel composite material of the present invention contains a wearing layer made of polymer PP, a colored layer made of ink and a printing layer made of polymer PP from top to bottom.

7. The production method of a novel composite material as claimed in claim 6, wherein the bottom of said printing layer is thermally polymerized with the stable layer made of polymer PP.

8. The production method of a novel composite material as claimed in claim 7, wherein the bottom of said stable layer is thermally polymerized with the deflation/silencing layer made of polymer PP.

9. The production method of a novel composite material as claimed in claim 8, wherein the bottom of said deflation/silencing layer is thermally polymerized with the heat-insulation layer made of polymer PP.
